(19) United States
(12) Patent Application Publication
(10) Pub. No.: US 2026/0251182 A1
(43) Pub. Date: Aug. 27, 2026

(54) BEARING HOUSING FOR TURBOCHARGER

(71) Applicant: BorgWarner Inc., Auburn Hills, MI (US)

(72) Inventor: Christian Charles Longacre, Arden, NC (US)

(73) Assignee: BorgWarner Inc., Auburrn Hills, MI (US)

(21) Appl. No.: 19/065,715

(22) Filed: Feb. 27, 2025

(51) Int. Cl. F16C 35/04; F16C 37/00

(52) U.S. Cl. CPC F16C 35/045; F16C 37/00; F16C 2204/20; F16C 2360/24

(57) ABSTRACT

A bearing housing for a turbocharger is disclosed. The bearing housing includes a bearing housing body and a flange positioned at an interface with an adjacent housing. A plurality of interruption zones are formed on the flange, with each interruption zone defining a gap or recess to interrupt thermal conduction paths. The interruption zones are configured to direct heat flux away from the bearing housing body, thereby reducing thermal stress and improving the durability and thermal management of the bearing housing under high-temperature operating conditions

### TECHNICAL FIELD

The present disclosure generally relates to turbocharger components for internal combustion engines, and more particularly to bearing housings used in turbochargers.

### BACKGROUND

Turbochargers are widely utilized in internal combustion engines to enhance performance and efficiency by compressing intake air, enabling higher power density. These devices help engines generate more power without significantly increasing their size, making them integral to modern vehicle designs.

However, turbocharger systems, particularly those involving Variable Turbine Geometry (VTG) configurations, face significant thermal challenges. The bearing housing, which connects the turbine housing and compressor housing, is subjected to high heat flux during operation. This heat transfer from the turbine housing to the bearing housing can cause the bearing housing flange temperatures to exceed 450° C., resulting in substantial thermal stress.

Effective cooling of the bearing housing is crucial to maintaining its structural integrity. Despite the inclusion of water-cooling systems, it is often difficult to deliver enough cooling to critical areas, especially at the outer radial locations or near the bearing housing-turbine housing flange. These regions are particularly susceptible to hot spots due to inadequate thermal dissipation.

Over time, the exposure to high temperatures can degrade the material properties of the bearing housing, leading to cracking and structural failure at the flange. Such failures compromise the performance and durability of the turbocharger, necessitating costly repairs and replacements.

It can therefore be seen that a need exists for a bearing housing design that effectively manages heat transfer from the turbine housing to the bearing housing, ensuring enough cooling even in areas with high heat flux. Such a design would reduce thermal stress, prevent material degradation, and address cracking issues at the bearing housing-turbine housing flange, thereby improving the durability and operational lifespan of turbocharger systems.

### SUMMARY

In accordance with one aspect of the disclosure, a bearing housing for a turbocharger is provided. The bearing housing comprises a bearing housing body and a flange positioned at an interface with an adjacent housing. The flange includes at least one interruption zone, the interruption zone defining a gap or recess to interrupt thermal conduction paths. The interruption zone is configured to direct heat flux away from the bearing housing body, thereby reducing thermal stress and improving the operational durability of the bearing housing. This configuration enhances the thermal management of the turbocharger under high-temperature operating conditions.

In accordance with another aspect of the disclosure, a turbocharger system is provided. The turbocharger system comprises a turbine housing configured to receive exhaust gases from an internal combustion engine, a compressor housing configured to receive compressed air from a rotor shaft, and a bearing housing connecting the turbine housing and the compressor housing. The bearing housing includes a bearing housing body and a flange positioned at an interface with an adjacent housing. The flange incorporates at least one interruption zone, the interruption zone defining a gap or recess to interrupt thermal conduction paths. The interruption zone is configured to direct heat flux away from the bearing housing body, thereby reducing thermal stress and enhancing the durability and thermal efficiency of the turbocharger system.

In accordance with yet another aspect of the disclosure, a method of reducing thermal stress in a bearing housing of a turbocharger is provided. The method comprises forming a bearing housing body with a flange along a circumference of the bearing housing body for interfacing with an adjacent housing component. The method further includes machining a plurality of interruption zones in the flange, each interruption zone defining a gap or recess to interrupt a thermal conduction path between the bearing housing and the adjacent housing component. This method improves thermal management by redirecting heat flux away from the bearing housing, reducing thermal stress, and enhancing the durability and operational efficiency of the turbocharger.

These and other aspects and features of the present disclosure will be better understood upon reading the following detailed description when read in conjunction with the accompanying drawings.

### BRIEF DESCRIPTION OF THE DRAWINGS

FIG. 1 is a cross-sectional view of a turbocharger assembly, illustrating the turbine housing, bearing housing, and compressor housing, according to an embodiment of the present disclosure.

FIG. 2 is a perspective side view of the bearing housing, according to an embodiment of the present disclosure.

FIG. 3 is a top schematic view of the bearing housing, illustrating the arrangement of thermal interruption zones, according to an embodiment of the present disclosure.

FIG. 4 is a perspective top view of the bearing housing, showing the configuration of interruption zones for heat dissipation, according to an embodiment of the present disclosure.

FIG. 5 is a close-up view of the BH-TH housing interface between the bearing housing and the turbine housing, illustrating the flange of the bearing housing interfacing with the turbine housing, according to an embodiment of the present disclosure.

FIG. 6 is a close-up side view of the BH-TH housing interface, showing the interruption zones as gaps to redirect heat flux, according to an embodiment of the present disclosure.

FIG. 7 is a close-up perspective view of the BH-TH housing interface, showing the gap created by the interruption zones for improved thermal management, according to another embodiment of the present disclosure.

FIG. 8 is a flow-chart of a method of reducing thermal stress in a bearing housing of a turbocharger, according to an embodiment of the present disclosure.

The figures depict one embodiment of the presented invention for purposes of illustration only. One skilled in the art will readily recognize from the following discussion that alternative embodiments of the structures and methods illustrated herein may be employed without departing from the principles described herein.

### DETAILED DESCRIPTION

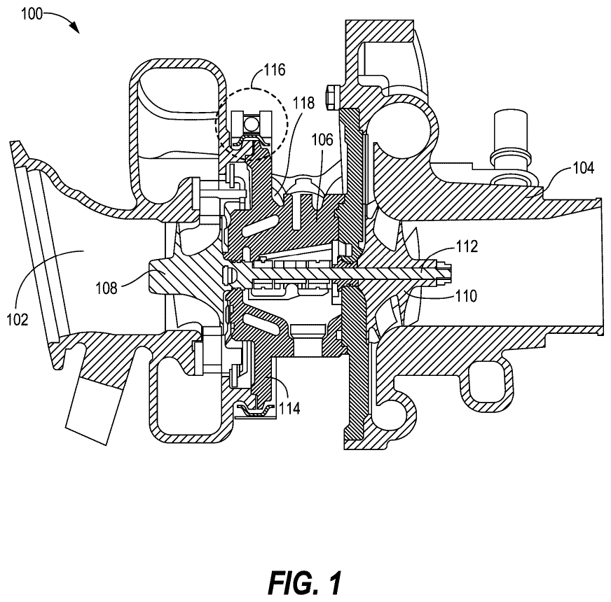

Referring now to the drawings, and with specific reference to the depicted example in FIG. 1, a turbocharger 100 is shown in cross-sectional view. While the following detailed description describes an exemplary embodiment in connection with a turbocharger 100 for internal combustion engines, it should be appreciated that the description applies equally to other applications, including but not limited to gasoline or diesel engines in passenger vehicles, trucks, industrial machinery, and marine engines, as well as other high-performance power systems requiring advanced thermal management and durability.

Referring now to FIG. 1, a cross-sectional view of a turbocharger 100 is illustrated, according to an embodiment of the present disclosure. The turbocharger 100 includes a turbine housing 102, a compressor housing 104, and a bearing housing 106 that interconnects the turbine housing 102 and the compressor housing 104. A turbine wheel 108 is located within the turbine housing 102 and is coupled to a compressor wheel 110 within the compressor housing 104 via a rotor shaft 112. The rotor shaft 112 extends through the bearing housing 106, which provides structural support and accommodates bearings for rotational movement of the rotor shaft 112.

The bearing housing 106 includes a bearing housing body 114, which defines a shaft bore for accommodating the rotor shaft 112. The bearing housing 106 may further incorporate one or more cooling cores 118 configured to provide enhanced thermal management. The cooling cores 118 are positioned within or adjacent to the bearing housing body 114 and are designed to circulate a cooling medium, such as water or oil, to effectively reduce localized thermal stress. By integrating cooling cores 118, heat generated at the BH-TH interface 116 and other critical areas of the bearing housing 106 can be dissipated more efficiently, ensuring the operational durability of the turbocharger 100 under high-temperature conditions. The geometry of the cooling cores 118 can vary depending on the application and thermal load. For example, the cooling cores 118 may be designed as helically shaped channels encircling the rotor shaft 112 to maximize heat transfer efficiency, or as linear passages running radially along the bearing housing body 114 to target specific areas of thermal stress. In some embodiments, the cooling cores 118 may also include fins or turbulators to promote turbulent flow, increasing the heat exchange efficiency between the coolant medium and the internal surfaces of the cooling cores 118

The turbine housing 102 receives exhaust gases from an internal combustion engine through an inlet passage. The exhaust gases drive the turbine wheel 108, causing it to rotate. This rotational energy is transferred via the rotor shaft 112 to the compressor wheel 110, which compresses intake air. Compressed air exits the compressor housing 104 through an outlet passage and is directed to the engine for combustion.

The bearing housing 106 is configured to interface with the turbine housing 102 at a bearing housing-turbine housing interface 116 (“BH-TH interface 116”). The bearing housing 106 may be bolted and/or integrated with the turbine housing 102 in the turbocharger 100.

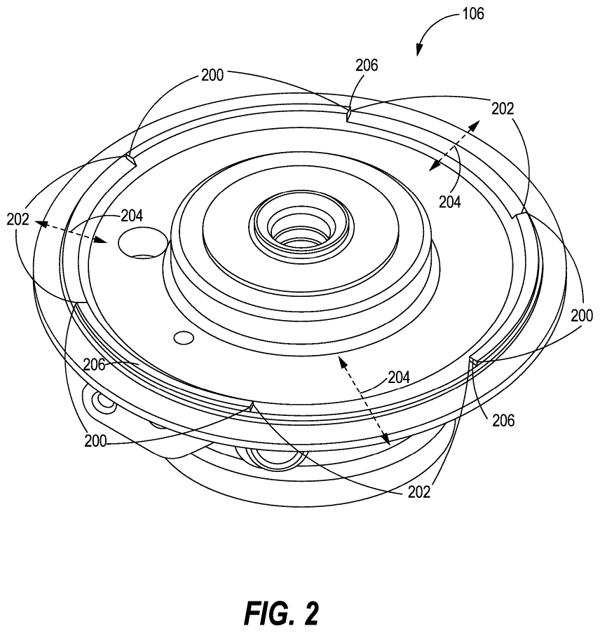

Referring now to FIG. 2, a perspective side view of the bearing housing 106 is illustrated, according to an embodiment of the present disclosure. The bearing housing body 120 includes a flange 200 configured to interface with the turbine housing 102. The flange 200 extends radially from the bearing housing body 120.

The flange 200 incorporates a plurality of interruption zones 202 distributed strategically along its surface. These interruption zones 202 are designed as recesses or gaps that alter the thermal conduction path, thereby improving thermal management. By redirecting heat flux, the interruption zones 202 assist in maintaining lower temperatures in critical areas of the bearing housing 106.

In some embodiments, the bearing housing 106 may include a single interruption zone 202 positioned on the flange 200. This single interruption zone 202 may extend radially across a limited portion of a circumference of the flange 200, disrupting thermal conduction at a localized region or “hot spot.” Such a configuration can be advantageous for applications requiring targeted thermal management in areas of high heat flux, while maintaining the structural strength of the remaining regions of the flange 200.

In one embodiment, the cooling cores 118 may include channels, passages, or cavities formed within the bearing housing body 114. These channels are connected to an external cooling system that supplies a coolant medium, such as engine coolant or a dedicated cooling fluid. The flow of coolant through the cooling cores 118 is configured to remove heat from high-flux regions of the bearing housing 106, particularly near the flange 200 and the shaft bore of the rotor shaft 112. The cooling cores 118 may be strategically placed to address specific thermal challenges, such as hot spots near the bearing housing-turbine housing interface 116

In some embodiments, the interruption zones 202 are symmetrically positioned around the circumference of the flange 200. As shown in FIG. 2, each interruption zone 202 is recessed into the flange 200 and extends radially to optimize heat dissipation. This arrangement contributes to the overall thermal performance of the bearing housing 106 without affecting its structural integrity.

The interruption zones 202 are dimensioned to provide a balance between heat dissipation and structural strength. For example, the width of each interruption zone 202 may range from approximately 1 mm to 100 mm. The design ensures that the interruption zones 202 reduce heat transfer effectively while maintaining the flange 200's ability to securely connect the turbine housing 102 and the bearing housing 106.

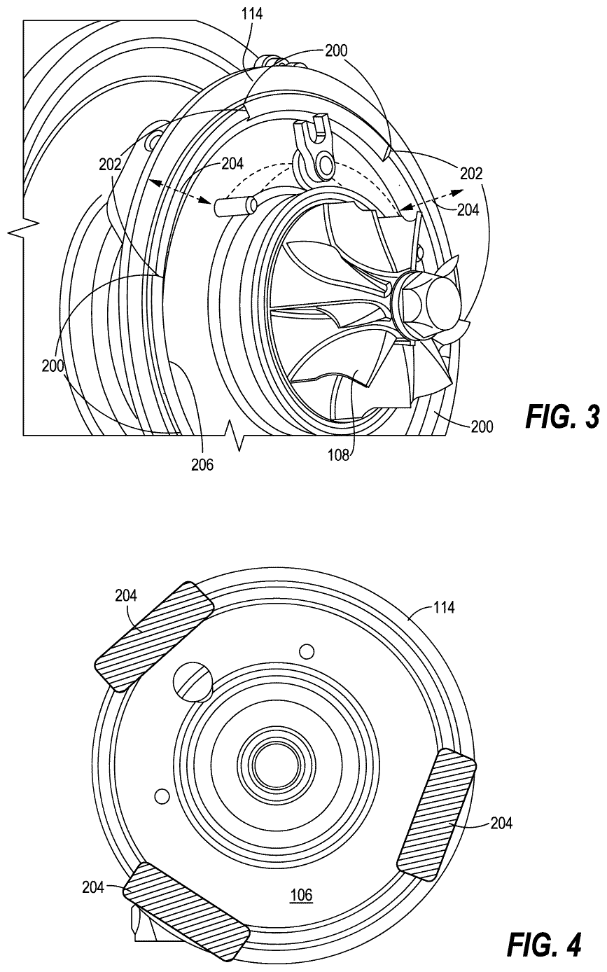

Referring now to FIG. 3, a top schematic view of the bearing housing 106 is shown, illustrating the spatial arrangement of the interruption zones 202 around the flange 200. In this embodiment, three interruption zones 202 are equidistantly spaced at approximately 120-degree intervals. Open regions 204 between adjacent interruption zones 202 provide additional thermal dissipation by promoting convection of heat away.

The connection surfaces 206 at the radial edges of the flange 200 are configured to interface securely with the turbine housing 102. These surfaces are positioned to complement the interruption zones 202, ensuring effective thermal management without compromising the mechanical connection between the components.

Referring now to FIG. 4, a perspective top view of the bearing housing 106 is illustrated, highlighting the relationship between the interruption zones 202 and the open regions 204. The recessed design of the interruption zones 202 creates offsets that enhance the thermal management characteristics of the flange 200, directing heat flux away from the bearing housing body 12.

The open regions 204 formed between the interruption zones 202 contribute to heat dissipation through convection and conduction, reducing thermal buildup in the flange 200. This design ensures that the flange 200 can withstand high-temperature operating conditions while maintaining structural reliability. The cooling cores 118 complement the thermal interruption zones 202 and open regions 204 described herein, providing a multi-faceted approach to thermal management in the bearing housing 106. While the interruption zones 202 act to disrupt thermal conduction paths and promote natural convection, the cooling cores 118 actively remove heat through forced convection by circulating a coolant medium.

The bearing housing 106, including the bearing housing body 120 and flange 200, is constructed from materials capable of withstanding significant thermal and mechanical stress. For example, an aluminum alloy may be used to enhance thermal conductivity and durability. This material choice, combined with the arrangement of interruption zones 202 and open regions 204, ensures that the bearing housing 106 remains effective and durable under high heat flux conditions. Additionally, the bearing housing 106 may be made of cast iron or similar casting materials.

The bearing housing body 120 and flange 200 are constructed from thermally conductive and durable materials capable of withstanding high thermal loads. In certain embodiments, an aluminum alloy with a thermal conductivity greater than 150 W/m·K may be used. This material ensures efficient heat dissipation from the bearing housing body 120 while maintaining mechanical strength to resist deformation under thermal and mechanical stresses. Alternatively, other materials such as high-temperature alloys or composites may be utilized depending on the specific operating conditions.

The design of the bearing housing 106, integrated with the flange 200, the interruption zones 202, and open regions 204, provides a robust solution for managing thermal loads in the turbocharger 100. This supports reliable performance and extended operational lifespan of the turbocharger 100 while ensuring optimal thermal efficiency. In some embodiments, a thermal barrier coating may be applied to the flange 200 to further enhance heat dissipation and reduce heat absorption into the bearing housing 106. The thermal barrier coating may be composed of a ceramic-based material or other insulating compounds known for their ability to withstand high temperatures and prevent thermal conduction. This additional layer of protection enhances the operational durability of the bearing housing 106 in environments with extreme heat flux.

Referring now to FIG. 5, a close-up view of the interface between the bearing housing 106 and the turbine housing 102 is illustrated, according to an embodiment of the present disclosure. The flange 200 of the bearing housing 106 aligns with a mating surface on the turbine housing 102, ensuring precise coupling. The interruption zones 202 on the flange 200 are positioned to manage the thermal conduction path at this interface, reducing the heat transferred from the turbine housing 102 to the bearing housing 106. These features maintain thermal stability in high-temperature regions near the turbine housing 102.

The interruption zones 202 are configured to limit direct contact between the flange 200 and the turbine housing 102. This design minimizes the heat transfer while maintaining structural integrity to ensure secure alignment and operational reliability. The open regions 204 formed between the interruption zones 202 provide additional pathways for convection cooling, further enhancing the thermal management capabilities of the bearing housing 106.

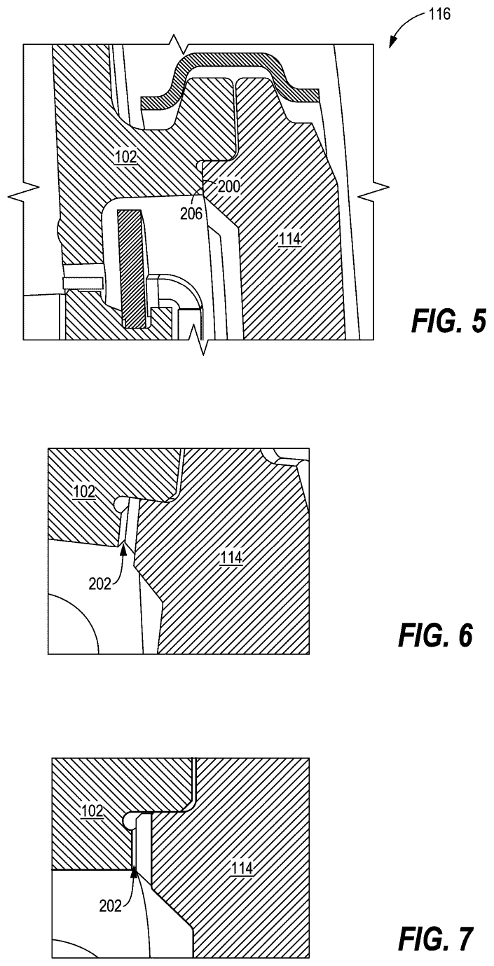

Referring now to FIG. 6, a close-up side view of the interface between the bearing housing 106 and turbine housing 102 is illustrated, showing the interruption zones 202 as gaps positioned along the flange 200. This side view highlights the depth and spacing of the interruption zones 202, which create thermal offsets along the flange 200. These gaps ensure that heat flux from the turbine housing 102 is redirected away from critical areas of the bearing housing 106. The configuration promotes enhanced heat dissipation, preventing localized hot spots that could degrade material properties or cause structural failures.

Referring now to FIG. 7, a close-up perspective view of the interface between the bearing housing 106 and the turbine housing 102 is illustrated, according to another embodiment of the present disclosure. This view provides additional detail of the interruption zones 202 and the gaps they create along the flange 200. The perspective view demonstrates how the gaps establish discrete regions of thermal isolation, reducing direct heat transfer between the turbine housing 102 and the bearing housing 106. The arrangement of the gaps further facilitates natural convection, allowing air to circulate and dissipate heat efficiently from the flange 200.

The machining process for forming the interruption zones 202 may include precision techniques such as CNC milling, laser cutting, or electrical discharge machining (EDM). Alternatively, the interruption zones 202 may be formed by casting, die casting, or other casting method as generally known in the arts. These methods allow for the formation of highly accurate and consistent interruption zones 202 with controlled dimensions. For example, the width and depth of the gaps or recesses may be adjusted during machining to optimize thermal dissipation while maintaining the structural integrity of the flange 200. The process may also involve finishing treatments to ensure smooth surfaces within the interruption zones 202, reducing potential stress concentrations that could otherwise lead to material fatigue or cracking.

Together, the configurations shown in FIGS. 5, 6, and 7 illustrate the strategic use of interruption zones 202 and gaps to manage thermal loads at the BH-TH interface 116. These features enhance the overall thermal performance of the turbocharger 100, improving reliability and operational lifespan under high-temperature conditions.

### INDUSTRIAL APPLICABILITY

In operation, the present disclosure has applicability across numerous industries, including but not limited to automotive, construction, power generation, agricultural, and heavy machinery industries. Specifically, the systems, components, and methods described herein may be employed in turbocharged engines for passenger vehicles, trucks, industrial machinery, and marine engines. These teachings are particularly beneficial in environments requiring advanced thermal management for components in turbochargers subjected to high temperatures, such as the bearing housing 106.

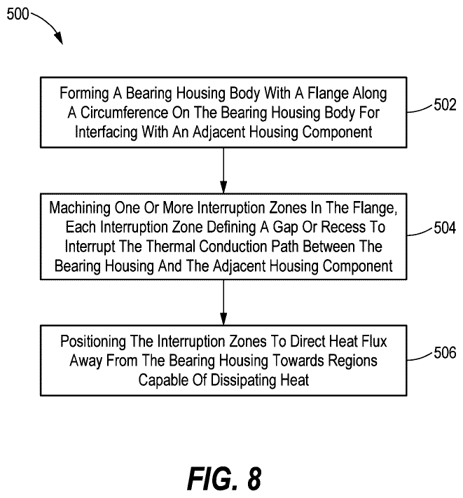

Referring now to FIG. 8, a method 500 of reducing thermal stress in a bearing housing 106 of a turbocharger 100 is illustrated. This method 500 involves forming, machining, and strategically positioning features within the bearing housing 106 to manage heat transfer and prolong the operational life of the turbocharger 100.

In a step 504, the method 500 includes machining one or more interruption zones 202 into the flange 200. Each interruption zone 202 defines a gap or recess that disrupts the thermal conduction path between the bearing housing 106 and the turbine housing 102. These interruption zones 202 are spaced symmetrically around the flange 200 to ensure uniform thermal management across the interface. The machining process can involve precision techniques when forming the interruption zone 202 to achieve optimized dimensions for heat redirection.

In a step 506, the method 500 includes positioning the interruption zones 202 to direct heat flux away from the bearing housing 106 towards regions capable of dissipating heat more efficiently. The interruption zones 202 and open regions 204 between them allow natural convection and conduction to remove accumulated heat. This configuration prevents hot spots in the flange 200 and maintains the structural integrity of the bearing housing 106, even under prolonged exposure to high-temperature operating conditions.

The method 500 described herein addresses thermal management challenges in the turbocharger 100, particularly in regions where high heat flux is transferred from the turbine housing 102 to the bearing housing 106. By implementing these steps, the method 500 ensures improved thermal stability, reduced risk of material degradation, and enhanced reliability of the turbocharger 100 in demanding operating environments. The teachings described herein also apply to turbocharged engines in hybrid powertrains, where thermal management remains critical to achieving optimal performance. By integrating the described bearing housing designs, such systems can better accommodate fluctuating temperature loads caused by dynamic engine operation. Furthermore, the interruption zones 202 described herein may be adapted for use in other thermal management systems, such as those in gas turbines or heat exchangers, to enhance durability and efficiency across a wide range of industrial applications.

From the foregoing, the technology disclosed herein has industrial applicability in a wide range of settings, including but not limited to automotive, construction, mining, and agricultural industries. This technology is particularly useful for internal combustion engines equipped with turbochargers, where advanced thermal management is required to enhance durability, efficiency, and performance. The described systems, components, and methods can be applied to turbocharged engines for passenger vehicles, trucks, industrial machinery, and other high-performance systems requiring efficient thermal load distribution.

What is claimed is:

1. A bearing housing for a turbocharger, comprising:
a bearing housing body;
a flange on the bearing housing body at an interface with an adjacent housing;
an interruption zone formed in the flange, the interruption zone defining a gap or recess to interrupt thermal conduction paths; and
the interruption zone being configured to direct heat flux away from the bearing housing body for reducing thermal stress on the bearing housing.

2. The bearing housing of claim 1, wherein a plurality of interruption zones are provided on the flange.

3. The bearing housing of claim 2, wherein the plurality of interruption zones are spaced evenly around the flange.

4. The bearing housing of claim 1, further comprising at least one cooling core positioned within the bearing housing body for circulating a cooling medium.

5. The bearing housing of claim 2, wherein each of the plurality of interruption zones are elongated gaps.

6. The bearing housing of claim 1, further comprising a thermal coating applied on the flange to enhance heat dissipation.

7. The bearing housing of claim 1, wherein the flange is casted or machined to form the gap or recesses formed on the bearing housing body.

8. The bearing housing of claim 1, wherein the bearing housing body is made of an aluminum alloy with a thermal conductivity greater than 150 W/m·K.

9. A turbocharger comprising:
a turbine housing configured to receive exhaust gases from an internal combustion engine;
a compressor housing configured to receive compressed air from a rotor shaft;
a bearing housing connecting the turbine housing and the compressor housing, the bearing housing including:
a bearing housing body;
a flange on the bearing housing body at an interface with an adjacent housing;
an interruption zone formed in the flange, the interruption zone defining a gap or recess to interrupt thermal conduction paths; and
the interruption zone being configured to direct heat flux away from the bearing housing body for reducing thermal stress on the bearing housing.

10. The turbocharger of claim 9, wherein a plurality of interruption zones are provided on the flange.

11. The turbocharger of claim 10, wherein the plurality of interruption zones form an air gap in a bearing housing-turbine housing interface configured to allow convection cooling.

12. The turbocharger of claim 10, further comprising a thermal insulation layer positioned between the bearing housing and the compressor housing.

13. The turbocharger of claim 10, wherein the plurality of interruption zones are spaced evenly around the flange.

14. The turbocharger of claim 10, further comprising at least one cooling core positioned within the bearing housing body for circulating a cooling medium.

15. The turbocharger of claim 10, wherein the plurality of interruption zones are elongated gaps.

16. The turbocharger of claim 10, wherein the flange is casted or machined to form the plurality of interruption zones.

17. A method of reducing thermal stress in a bearing housing of a turbocharger, the method comprising:
forming a bearing housing body with a flange along a circumference on the bearing housing body for interfacing with an adjacent housing component; and
casting or machining a plurality of interruption zones in the flange, each interruption zone defining a gap or recess to interrupt a thermal conduction path between the bearing housing and the adjacent housing component.

18. The method of claim 17, positioning the plurality of interruption zones to direct heat flux away from the bearing housing towards regions capable of dissipating heat more efficiently.

19. The method of claim 18, further comprising applying a thermal barrier coating to the flange to reduce heat absorption.

20. The method of claim 19, further comprising casting or machining the plurality of interruption zones in elongated gaps.
